(19) United States
(12) Patent Application Publication
(10) Pub. No.: US 2025/0088799 A1
(43) Pub. Date: Mar. 13, 2025

(54) VIBRATION DEVICE AND VIBRATION METHOD

(71) Applicant: AGC Inc., Tokyo (JP)

(72) Inventor: Jun AKIYAMA, Tokyo (JP)

(21) Appl. No.: 18/955,821

(22) Filed: Nov. 21, 2024

Related U.S. Application Data
(63) Continuation of application No. PCT/JP2023/018329, filed on May 16, 2023.

(30) Foreign Application Priority Data
May 23, 2022 (JP) 2022-083970

(51) Int. Cl. H04R 3/04; H04R 1/02; H04R 7/04; H04R 29/00

(52) U.S. Cl. CPC H04R 3/04; H04R 1/028; H04R 7/04; H04R 29/001; H04R 2307/023; H04R 2499/13

(57) ABSTRACT

A vibration device including a glass sheet composite equipped with at least one sheet of glass plate, a vibration output unit that is fixed to the glass sheet composite and that vibrates the glass sheet composite according to a signal that has been input, a detection unit that detects sound or vibration emitted by the glass sheet composite and outputs a detection signal according to a detection result, a signal output unit that outputs any selected audio signal, and a control unit that includes a controller that generates a corrected signal obtained by correcting the audio signal such that the detection signal and the audio signal correspond, and that inputs the corrected signal from the controller into the vibration output unit.

### CROSS-REFERENCE TO RELATED APPLICATION

This application is a continuation application of International Application No. PCT/JP2023/018329 filed May 16, 2023 the disclosure of which is incorporated herein by reference in its entirety. Further, this application claims priorities from Japanese Patent Application No. 2022-083970 filed on May 23, 2022, the disclosure of which is incorporated herein by reference in their entirety.

### TECHNICAL FIELD

Technology disclosed herein relates to a vibration device and a vibration method.

### BACKGROUND ART

Technology is known that vibrates a glass plate to give good acoustic characteristics (International Publication (WO) No. 2019/172076).

A speaker device described in WO No. 2019/172076 includes a vibration plate having light transparency (for example, a glass plate, a translucent ceramic, or the like), an exciter (excitation device) that generates vibration, and a vibration transfer unit that is connected to the vibration plate and to the exciter, and that transfers vibration from the exciter to the vibration plate. A loss factor of such a vibration plate at 25° C. is 1×10⁻² or greater, a specific elastic modulus of the vibration transfer unit is 20 mm²/s² or greater, and excellent styling characteristics are exhibited without detriment to the design characteristics of the vibration plate while maintaining acoustic performance.

Moreover, a device is known that detects sound of a noise source, and also reduces interior noise by outputting noise of the opposite phase to the detected sound (Japanese Patent Application Laid-Open (JP-A) No. H9-288489).

In the noise reduction device of JP-A No. H9-288489, an audio signal of the frequency of noise detected by a first microphone arranged in a vehicle interior is output and, according to this audio signal, sound having the same amplitude and opposite phase to the detected noise is generated toward the vehicle interior as an opposite phase sound (secondary sound) from a speaker arranged in a headrest. A second microphone arranged in the vicinity of the speaker detects residual noise in the vehicle interior, and inputs a detection signal that has been detected into a control means. Based on the audio signal and the detection signal, the control means updates a coefficient of an adaptive filter employing an adaptive algorithm so as to minimize the detection signal, and the opposite phase sound output from the speaker is controlled.

In this noise reduction device, noise audible by an occupant in the vehicle interior is reduced by outputting the opposite phase sound of noise from an inbuilt speaker in the headrest.

Moreover, a known noise device includes a vibration output unit that vibrates a window glass plate partitioning between an interior space and an exterior space, a feedforward microphone that detects a noise source/vibration source correlated to sound wave vibration induced in the glass plate, and outputs a reference signal according to the detection result, a feedback microphone that detects sound in the interior space and outputs an error signal according to the detection result, and ANC processing that includes a filter to generate a cancellation signal having a opposite phase to the reference signal such that the error signal is minimized and that outputs the cancellation signal to the vibration output unit (US2018/0082673A).

The noise device of US2018/0082673A generates a destructive interference signal for use in active noise cancellation in an internal setting of the interior space.

### SUMMARY OF INVENTION

### Technical Problem

The speaker device described in WO No. 2019/172076 accordingly includes an intermediate layer provided between a sheet-pair of substrates (for example, glass plates), and discloses that a high loss factor can realized when the intermediate layer is a liquid, and that good vibration transfer is obtained due to having a thin thickness. JP-A No. H9-288489 and US2018/0082673A do not disclose technology to reduce noise in a vehicle interior space.

Due to the effect of inertial force being large when a glass plate gets bigger, there is a problem that there is a drop in signal reproducibility at rise up and fall of the input signal. Furthermore, a glass vibration plate to excite a glass plate that is both big and large in mass results in a problem suppressing drive noise emitted from the exciter. For example, in cases in which a speaker device is employed as a vibration (sound) generation unit, if provided between an interior and an exterior of a vehicle, building, or the like, then there is a concern that sufficient vibration performance might not be obtained due to the external air temperature. This is caused by the vibration frequency characteristics of a glass vibration plate having a temperature dependency. At low temperatures attenuation properties fall and a glass vibration plate is liable to resonate, and at high temperatures attenuation properties of the glass vibration plate rise and transient response properties fall, and there is a concern that desired performance is no longer obtainable. There is accordingly demand for a function to correct vibration behavior of a glass vibration plate.

An object of technology disclosed herein is to provide a vibration device and a vibration method employing a glass vibration plate and capable of outputting sound faithful to an audio signal.

### Solution to Problem

A first aspect of the present disclosure is a vibration device, including:
a glass sheet composite equipped with at least one sheet of glass plate;
a vibration output unit that is fixed to the glass sheet composite and that vibrates the glass sheet composite according to a signal that has been input;
a detection unit that detects sound or vibration emitted by the glass sheet composite and outputs a detection signal according to a detection result;
a signal output unit that outputs any selected audio signal; and
a control unit that includes a controller that generates a corrected signal obtained by correcting the audio signal such that the detection signal and the audio signal correspond, and that inputs the corrected signal from the controller into the vibration output unit.

A second aspect of the present disclosure is a vibration method that vibrates a glass sheet composite equipped with at least one sheet of glass plate according to a signal that has been input using a vibration output unit that is fixed to the glass sheet composite, the vibration method including:
detecting sound or vibration emitted by the glass sheet composite and outputting a detection signal according to a detection result;
outputting any selected audio signal;
using a controller to generate a corrected signal obtained by correcting the audio signal such that the detection signal and the audio signal correspond, and inputting the corrected signal from the controller into the vibration output unit; and
vibrating the glass sheet composite according to the corrected signal using the vibration output unit.

### Advantageous Effects

Aspects of the present disclosure are able to provide a vibration device and a vibration method employing a glass vibration plate and capable of outputting sound faithful to an audio signal.

### BRIEF DESCRIPTION OF DRAWINGS

FIG. 1 is a schematic configuration diagram of a vehicle applied with a vibration device according to a first exemplary embodiment.

FIG. 2 is a schematic configuration diagram of a door of a vehicle applied with a vibration device.

FIG. 3 is a face-on view of a vibration device to explain a configuration of a vibration device.

FIG. 4 is a cross-section taken along line IV-IV illustrated in FIG. 3.

FIG. 5 is a partial cross-section diagram illustrating a way in which a vibration output unit is attached to a glass sheet composite.

FIG. 6 is a functional block diagram of a vibration device applied to a vehicle.

FIG. 7A is a diagram illustrating a vibration waveform of a glass sheet composite when an audio signal without correction has been output.

FIG. 7B is a diagram illustrating a vibration waveform of a glass sheet composite when an audio signal with correction has been output.

FIG. 8A is a diagram illustrating a configuration example of controllers connected together in series to configure an adaptive filter.

FIG. 8B is a diagram illustrating a configuration example of controllers connected together in parallel to configure an adaptive filter.

FIG. 9 is an outline configuration diagram of a door of a vehicle mounted with a vibration device of another configuration.

FIG. 10 is a functional block diagram of a vibration device of another configuration.

FIG. 11 is a functional block diagram of a vibration device of another configuration.

FIG. 12 is a functional block diagram of a vibration device of another configuration.

FIG. 13 is a schematic diagram of a vibration device according to a second exemplary embodiment provided to a door of a vehicle.

FIG. 14 is a schematic cross-section taken along line III-III in FIG. 13.

FIG. 15 is a functional block diagram of a vibration device applied to a vehicle.

FIG. 16 is a schematic cross-section illustrating a configuration of a glass vibration plate.

FIG. 17 is a schematic cross-section of a glass vibration plate illustrating another placement example of a temperature regulation unit of FIG. 16.

FIG. 18A is an explanatory diagram illustrating a temperature regulation region by a temperature regulation unit disposed on a glass vibration plate of FIG. 13.

FIG. 18B is an explanatory diagram illustrating a temperature regulation region by a temperature regulation unit disposed on the glass vibration plate illustrated in FIG. 13.

FIG. 18C is an explanatory diagram illustrating a temperature regulation region by a temperature regulation unit disposed on the glass vibration plate illustrated in FIG. 13.

FIG. 18D is an explanatory diagram illustrating a temperature regulation region by a temperature regulation unit disposed on the glass vibration plate illustrated in FIG. 13.

FIG. 19 is a partial cross-section illustrating a configuration in which a thermal radiation reflection layer has been provided to a glass vibration plate.

FIG. 20 is a partial cross-section illustrating a configuration in which a plate thickness of one glass plate of a glass vibration plate is thinner than a plate thickness of another glass plate thereof.

FIG. 21 is a cross-section illustrating another configuration example of a glass vibration plate.

FIG. 22 is a plan view of a vehicle illustrating application locations of a glass vibration plate to a vehicle.

FIG. 23 is a schematic configuration diagram illustrating an example in which a glass vibration plate has been applied to a window in a home.

### DESCRIPTION OF EMBODIMENTS

Detailed explanation follows regarding configuration examples of technology disclosed herein, with reference to the drawings.

In technology disclosed herein, good sound quality is realized in a low frequency band, and a middle to high frequency band, by signal-corrected excitation of a glass vibration plate. A glass sheet composite employed as a glass vibration plate will be described in the following exemplary embodiments for examples of a window of a vehicle and a window of a home, however application targets are not limited thereto. Note that reference in the description below to a “glass vibration plate” is a general term including a configuration in which a vibration output unit 13 is attached to a glass sheet composite 11, described later.

### First Exemplary Embodiment

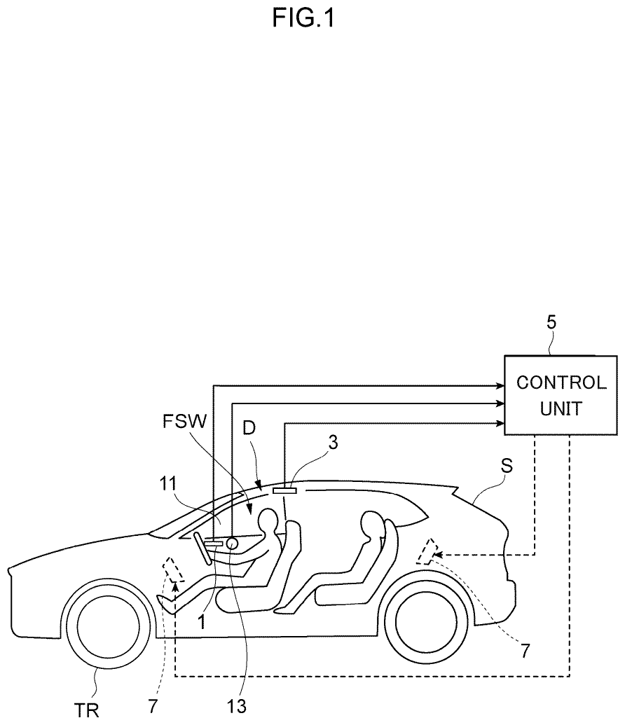

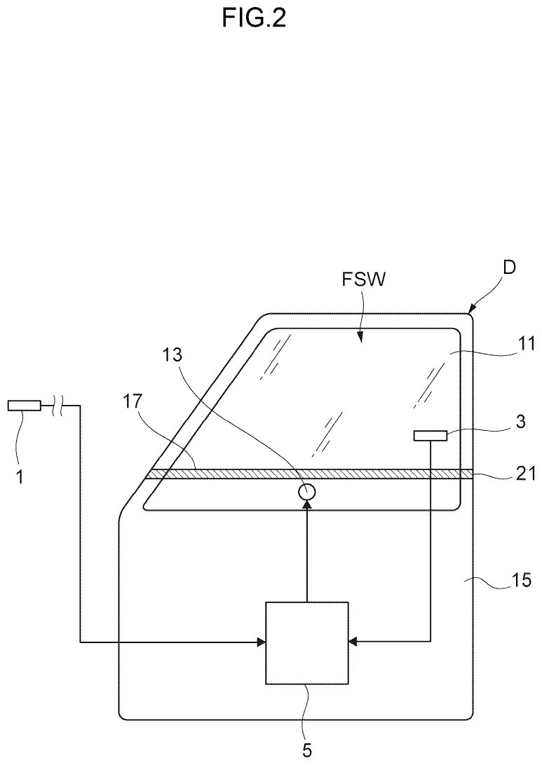

FIG. 1 is a schematic configuration diagram of a vehicle S applied with a vibration device. FIG. 2 is a schematic configuration diagram of a door D of a vehicle S applied with a vibration device.

As illustrated in FIG. 1, the vibration device is incorporated in the vehicle S, and emits sound to the exterior and the interior of the vehicle S.

As illustrated in FIG. 1 and FIG. 2, the vibration device includes a glass sheet composite 11, the vibration output unit 13, a sound output system 1, an interior sound detection unit 3, and a control unit 5. The vibration output unit 13, the sound output system 1, and the interior sound detection unit 3 are each connected to the control unit 5. Moreover, an audio speaker 7 configuring an audio system is provided in the interior of the vehicle S, and the audio speaker 7 is also connected to the control unit 5.

The glass sheet composite 11 is provided to the door D of the vehicle S, and is employed as a front side window FSW partitioning between an interior space and an exterior space of the vehicle S.

The vibration output unit 13 is, for example, a voice coil motor attached to the glass sheet composite 11. The vibration output unit 13 is vibrated by a drive signal input from the control unit 5, and imparts vibration thereof to the glass sheet composite 11.

The sound output system 1 is, for example, an audio reproduction system. The sound output system 1 outputs any selected audio signal. Specifically, the sound output system 1 is provided in the interior of the vehicle S, and the audio signal is transmitted to the control unit 5.

The interior sound detection unit 3 is, for example, a microphone, and is provided in the interior of the vehicle S to detect sound in the interior. The interior sound detection unit 3 is disposed in the interior, in the vicinity of the glass sheet composite 11 and the ears of an occupant, or preferably is in a state worn on the ears of an occupant. A wireless microphone is more preferable when in a state worn on the ears of an occupant. A signal of sound detected by the interior sound detection unit 3 is transmits as a detection signal to the control unit 5.

Moreover, the door D of the vehicle S provided with the glass sheet composite 11 includes an enclosing member 15 to support the glass sheet composite 11. A region of the glass sheet composite 11 where the vibration output unit 13 is affixed is housed in the interior of the enclosing member 15. The enclosing member 15 includes an opening 21, and a region of the glass sheet composite 11 where the vibration output unit 13 is not affixed is exposed to outside through the opening 21. The enclosing member 15 includes a shield member 17 provided to the opening 21, with acoustic shielding performed between the opening 21 and the glass sheet composite 11 by the shield member 17.

Explanation follows regarding a basic configuration of the vibration device.

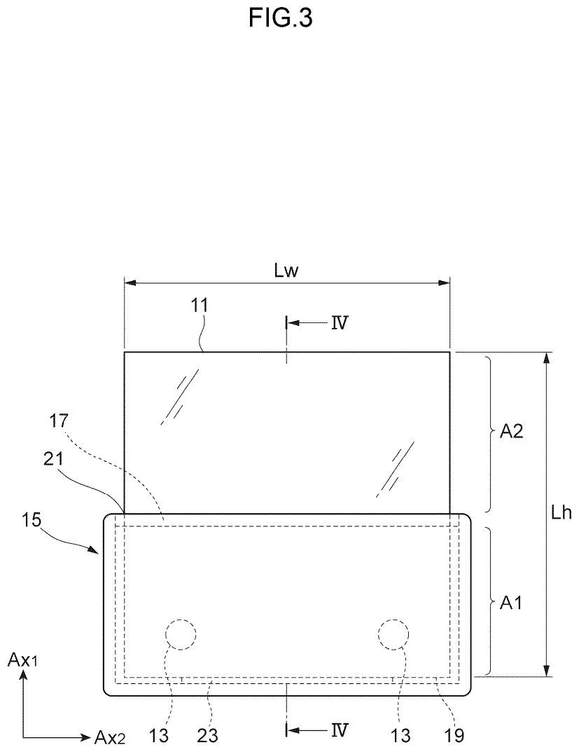

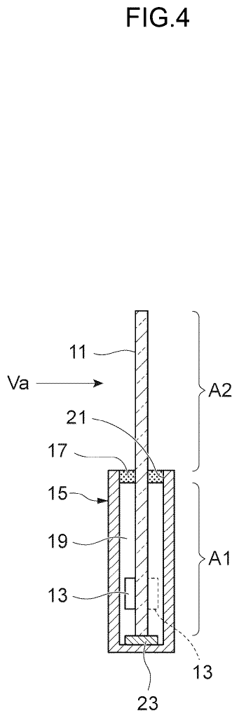

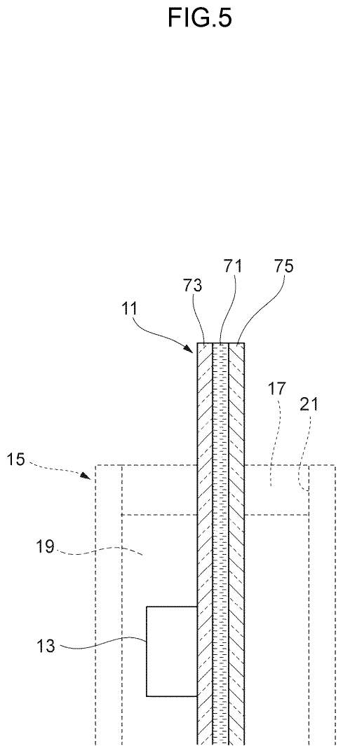

FIG. 3 is a face-on view of a vibration device to explain a configuration of a vibration device. FIG. 4 is a cross-section taken along line IV-IV illustrated in FIG. 3. FIG. 5 is a partial cross-section diagram illustrating a way in which the vibration output unit 13 is attached to the glass sheet composite 11.

As illustrated in FIG. 3 and FIG. 4, the glass sheet composite 11 is supported by the enclosing member 15. The glass sheet composite 11 is excited and generates sound by vibration generated by the vibration output unit 13. The glass sheet composite 11 may be translucent enabling the far side to be seen across the glass sheet composite 11 when looking in the direction of arrow Va of FIG. 4, may have light blocking properties, or may have selective optical transparency as in an optical filter such as a bandpass filter, a surface treatment layer on a surface configured as a light diffusing surface, or the like. A photochromatic film may be installed to a surface of a single plate glass when the glass sheet composite 11 is configured by a single sheet (single plate glass), or may be installed to plural intermediate layers when the glass sheet composite 11 is configured by laminated glass, described later.

The glass sheet composite 11 includes at least one sheet of glass plate. So-called laminated glass, in which plural glass plates are provided with intermediate layer(s) provided interposed between the glass plates, is preferable therefor. For example, as illustrated in FIG. 5, the glass sheet composite 11 of the present example is configured including a stacked sheet-pair of glass plates 73, 75, with an intermediate layer 71 interposed between these glass plates 73, 75. The glass sheet composite 11 preferably uses a material having a high speed of longitudinal wave sound and, for example, may use a material such as glass, a translucent ceramic, or a single crystal, such as sapphire or the like. The glass sheet composite 11 has an external shape matched to a front side window FSW of the vehicle S, however, there is no limitation thereto, and it may have another external shape such as a rectangular profile or the like.

The vibration output unit 13 is fixed to the glass sheet composite 11 and vibrates the glass sheet composite 11 according to an input drive signal. The vibration output unit 13 is, for example, configured including a coil section, a magnetic circuit section, and an excitation section coupled to the coil section or to the magnetic circuit section. In the vibration output unit 13, a vibration is generated in the coil section or the magnetic circuit section by interaction between the coil section and the magnetic circuit section when a drive signal is input to the coil section from the control unit 5. Vibration of the coil section or the magnetic circuit section is transferred to the excitation section, and is transferred from the excitation section to the glass sheet composite 11.

At least one vibration output unit 13 is attached to the glass sheet composite 11. Moreover, two of the vibration output units 13 may be attached to one of the main faces of the glass sheet composite 11, spaced apart from each other along one side of an outer edge of the glass sheet composite 11. Note that vibration output units 13 may be respectively provided to one main face and the other main face of the glass sheet composite 11, as illustrated by the vibration output unit 13 indicated by dotted line in FIG. 4.

The enclosing member 15 provided to the door D of the vehicle S is formed in a box shape surrounding a portion of the glass sheet composite 11 at a position where the vibration output unit 13 is affixed. The enclosing member 15 demarcates an interior space 19 including the vibration output unit 13 and part of the glass sheet composite 11. Other portions of the glass sheet composite 11 are exposed to the outside of the interior space 19 through the opening 21 of the interior space 19 formed to the enclosing member 15. Namely, part of the glass sheet composite 11 is exposed to the outside of the interior space 19 through the opening 21 of the interior space 19.

The shield member 17 provided to the opening 21 of the enclosing member 15 makes the interior space 19 a closed space, and divides the glass sheet composite 11 into an excitation region A1 at the inside of the interior space 19 where the vibration output unit 13 is provided, and a vibration region A2 at the outside of the interior space 19.

Examples of materials that may be employed as the shield member 17 include general high molecular weight materials and general rubbers, such as hydrocarbon compositions, silicone compositions, fluorine containing compositions. However, a material having a storage elastic modulus G of from 1.0×10² Pa to 1.0×10¹⁰ Pa when measuring the dynamic viscoelasticity of a molded sheet of thickness 1 mm at 25° C. and a frequency of 1 Hz in compression mode is preferable, and a material of from 1.0×10³ Pa to 1.0×10⁸ Pa is more preferable. Reference above to “shielding” by the shield member 17 means a state not completely fixed to the glass sheet composite 11, in which the shield member 17 contacts the glass sheet composite 11 to an extend allowing fine movements of 1 mm or less. Sound leakage from the interior space 19 is prevented from occurring thereby.

In the present configuration, a support member 23 is provided between a drive mechanism (omitted in the drawings), which is for raising or lowering the glass sheet composite 11 provided to a bottom portion of the interior space 19 of the enclosing member 15 or in the interior space 19, and a portion of the excitation region A1 of the glass sheet composite 11, with the support member 23 supporting the glass sheet composite 11 on the enclosing member 15. The support member 23 include cushioning properties and, for example, is made from a resilient sheet such as rubber, felt, sponge, or the like.

Note that the glass sheet composite 11 is able to be moved relative to the enclosing member 15 by the drive mechanism (omitted in the drawings). Namely, the window of the vehicle S is able to open or close by moving the front side window FSW configured from the glass sheet composite 11.

As illustrated in FIG. 3, when a first direction Ax1 is a direction in which the glass sheet composite 11 protrudes from the interior space 19 at the inside of the enclosing member 15 to outside the interior space 19, and a second direction Ax2 is a direction on the plate surface orthogonal to the first direction, preferably a maximum width Lw in the second direction Ax2 of the glass sheet composite 11 is at least a maximum width Lh in the first direction Ax1 (Lw≥Lh). This means that in the vibration region A2 of the glass sheet composite 11, a distance from the vibration output unit 13 disposed in the excitation region A1 of the glass sheet composite 11 is not excessively long across for the entire face of the vibration region A2, and vibration from the vibration output unit 13 is propagated sufficiently strongly to the vibration region A2.

Due to the configuration described above, the glass sheet composite 11 is divided by the shield member 17 into the excitation region A1 disposed in the interior space 19 of the enclosing member 15 where the vibration output unit 13 is attached, and the vibration region A2 that contributes to acoustic emission disposed at the outside of the interior space 19, as illustrated in FIG. 4. This means that sound generated from the excitation region A1 by vibration from the vibration output unit 13 is attenuated inside the interior space 19. Moreover, at the opening 21 of the interior space 19, a gap to the glass sheet composite 11 is acoustically shielded by the shield member 17, and sound from the excitation region A1 generated inside the interior space 19 is suppressed from leaking to outside the interior space 19.

Namely, when vibration of the vibration output unit 13 of the excitation region A1 propagates to the vibration region A2 and is acoustically emitted from the vibration region A2, the sound (noise) generated in the excitation region A1 can be suppressed from being superimposed on sound from the vibration region A2. Namely, a continuous single sheet of the glass sheet composite 11 is divided into the excitation region A1 and the vibration region A2, and the excitation region A1 is demarcated inside the interior space 19 by the enclosing member 15 and the shield member 17. This means that noise generated from the excitation region A1 is contained in the interior space 19 and sound suppressed from leaking from the interior space 19, and unnecessary noise generated from the excitation region A1 by vibration of the vibration output unit 13 is suppressed from being transmitted to a listener as air-propagated sound. As a result thereof, a fall in directionality arising from wraparound sound can be suppressed. Moreover, due to acoustic emission occurring in the peripheral only from the vibration region A2 of the glass sheet composite 11, a sound pressure distribution due to acoustic emission can be made uniform.

When Ss is a surface area of the excitation region A1 of the glass sheet composite 11 and Sv is a surface area of the vibration region, then a surface area ratio Ss/Sv is preferably from 0.01 to 1.0, is more preferably from 0.02 to 0.5, and is even more preferably from 0.05 to 0.1.

If a surface area of the excitation region A1 is too wide compared to the surface area of the vibration region A2 then sound pressure generation performance falls, and if too narrow then there is a concern that excitation driving may no longer be able to be performed efficiently. This means that by setting the surface area ratio in the above ranges, acoustic emission from the vibration region A2 is able to be performed at high efficiency according to vibration of the vibration output unit 13.

Moreover, a total surface area of the glass sheet composite 11 (surface area of one main face of the glass plate) is preferably 0.04 m² or greater, is more preferably 0.10 m² or greater, and is even more preferably 0.30 m² of greater. The total surface area of the glass sheet composite 11 being the above surface areas or greater facilitates uniformity in the sound pressure distribution as described above, and obtaining a directionality drop suppressing effect, by dividing into the excitation region A1 and the vibration region A2.

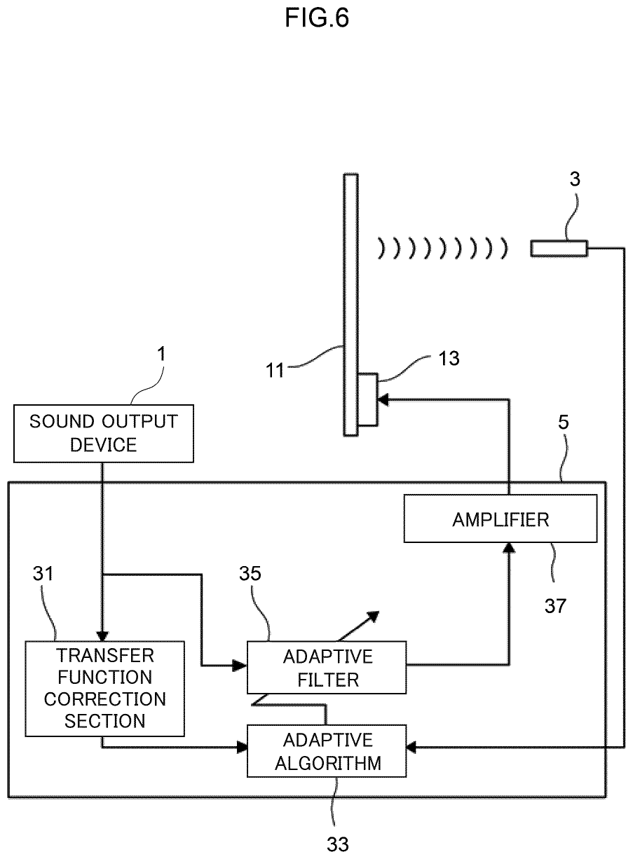

FIG. 6 is a functional block diagram of a vibration device applied to the vehicle S.

As illustrated in FIG. 6, the control unit 5 includes a transfer function correction section 31, an adaptive algorithm 33, an adaptive filter 35, and an amplifier 37. Although omitted in the drawings, the control unit 5 is configured from a microcomputer including a processor such as a CPU or the like, memory such as ROM and RAM, storage, and the like.

The adaptive algorithm 33 and the adaptive filter 35 generate a corrected signal obtained by correcting the audio signal transmitted from the sound output system 1. The adaptive algorithm 33 and the adaptive filter 35 generate the corrected signal obtained by correcting the audio signal such that the detection signal transmitted from the interior sound detection unit 3 and the audio signal correspond. The corrected signal generated by the adaptive algorithm 33 and the adaptive filter 35 is amplified by the amplifier 37 and transmitted to the vibration output unit 13. In the adaptive algorithm 33, for example, an error between the detection signal and the audio signal is estimated using a least squares method. In the adaptive filter 35, a filter coefficient from the adaptive algorithm 33 is appropriately updated according to a level of error between the detection signal and the audio signal.

The transfer function correction section 31 finds a transfer function of a secondary path that is a transfer path of the audio signal between the glass sheet composite 11 having the vibration output unit 13 attached thereto and serving as a secondary sound source, and the interior sound detection unit 3. The transfer function correction section 31 sets a parameter of the adaptive algorithm 33 based on this transfer function such that a phase of a detection signal from the interior sound detection unit 3 is synchronized with a phase of the audio signal from the sound output system 1.

In the vehicle S provided with the vibration device described above, any selected audio signal is transmitted to the control unit 5 by the sound output system 1 by actuating the vibration device. Moreover, interior sound is detected by the interior sound detection unit 3, and the detection result is transmitted to the control unit 5 as a detection signal.

When the audio signal and the detection signal are transmitted to the control unit 5, the transfer function correction section 31 of the control unit 5 finds a transfer function in the transfer path of the audio signal between the sound output system 1 and the interior sound detection unit 3. The phase of the detection signal from the interior sound detection unit 3 is synchronized with the phase of the audio signal from the sound output system 1 based on this transfer function.

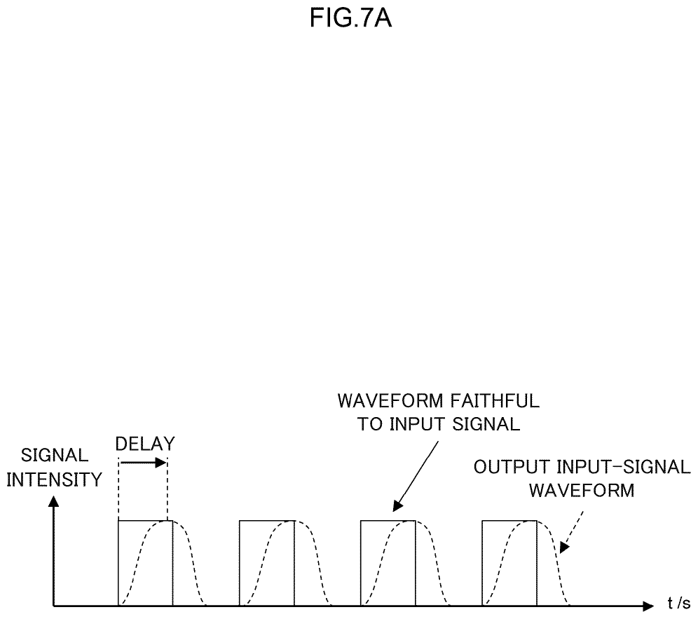

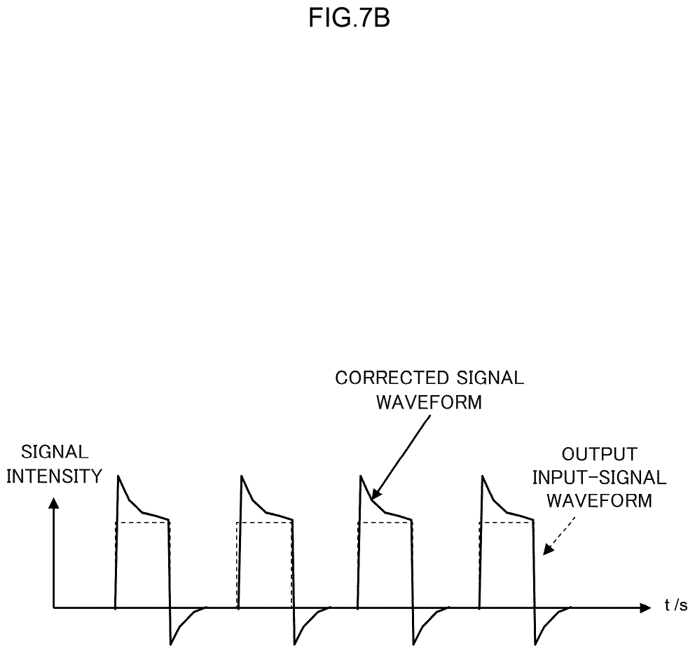

The glass sheet composite 11 has a large mass (inertia), and so reproducibility of the input signal is low directly after rise up and cutoff of the signal input, as illustrated in FIG. 7A. FIG. 7A illustrates an example in which a delay occurs in an output input-signal waveform (broken line), corresponding to the detection signal of the interior sound detection unit 3, compared to a waveform (solid line) faithful to the input signal of the vibration device, corresponding to the audio signal.

This means that in the present exemplary embodiment, the adaptive algorithm 33 and the adaptive filter 35 of the control unit 5 generate a corrected signal obtained by correcting the audio signal such that the detection signal transmitted from the interior sound detection unit 3 and the audio signal correspond. Specifically, as illustrated in FIG. 7B, a corrected signal is generated so as to raise the reproducibility of the input signal directly after rise up and cutoff of the signal input. FIG. 7B illustrates an example of a waveform (solid line) of a corrected signal and an output input-signal waveform (broken line) similar to the input signal of a vibration device. The corrected signal is transmitted to the amplifier 37, amplified by the amplifier 37, and transmitted to the vibration output unit 13. A voltage feedback amplifier or a current feedback amplifier may be employed as the amplifier 37, with a current feedback amplifier is preferably employed in order to obtain good response characteristics.

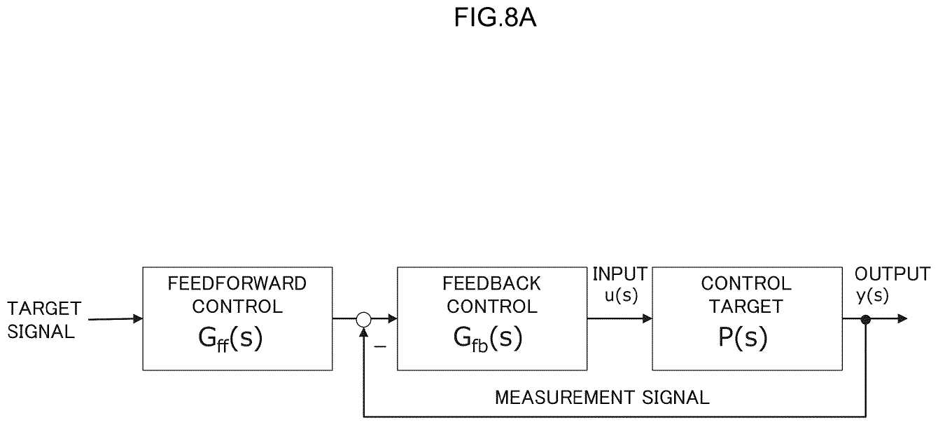

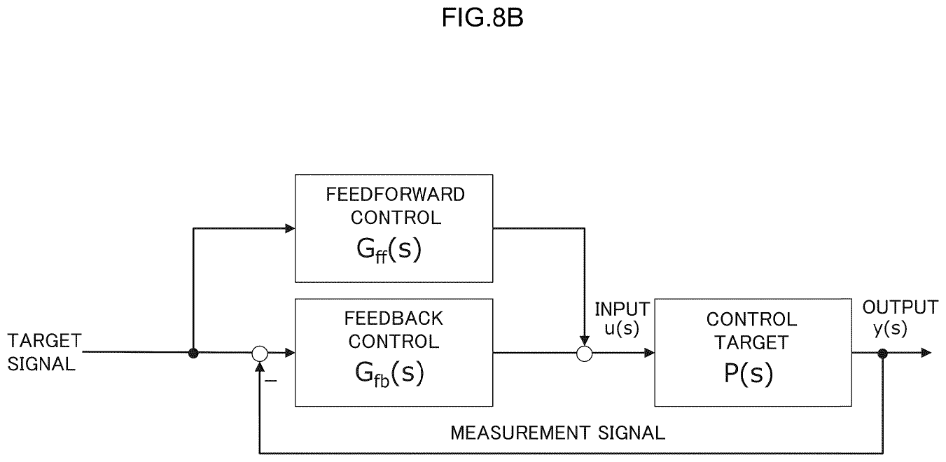

The adaptive filter 35 is specifically, as illustrated in FIG. 8A, configured by a feedforward controller Gff(s) and a feedback controller Gfb(s) as controllers connected together in series.

More specifically, a target value r(s) that is the audio signal is employed as input to the feedforward controller Gff(s), and a deviation(s) between the output of the feedforward controller Gff(s) and an output y(s) (measurement signal) that is the detection signal of the interior sound detection unit 3 is employed as input to the feedback controller Gfb(s). The control input u(s) that is the output of the feedback controller Gfb(s) is output to a control target P(s) that is the vibration output unit 13.

The adaptive filter 35 may, specifically as illustrated in FIG. 8B, be configured with a feedforward controller Gff(s) and a feedback controller Gfb(s) as controllers connected together in parallel.

More specifically, a target value r(s) that is the audio signal is employed as input to the feedforward controller Gff(s), and a deviation(s) between the target value r(s) that is the audio signal and an output y(s) (measurement signal) that is the detection signal of the interior sound detection unit 3 is employed as input to the feedback controller Gfb(s). A control input u(s) that is a sum of the output of the feedback controller Gfb(s) and the output of the feedforward controller Gff(s) is output to the control target P(s) that is the vibration output unit 13.

The vibration output unit 13 generates a vibration according to the corrected signal that has been transmitted, and thereby vibrates the glass sheet composite 11 to which the vibration output unit 13 has been attached. This means that vibration generated in the glass sheet composite 11 by vibration by the vibration output unit 13 enables output of sound that is faithful to the audio signal.

Next, description follows regarding another configuration example of a vibration device.

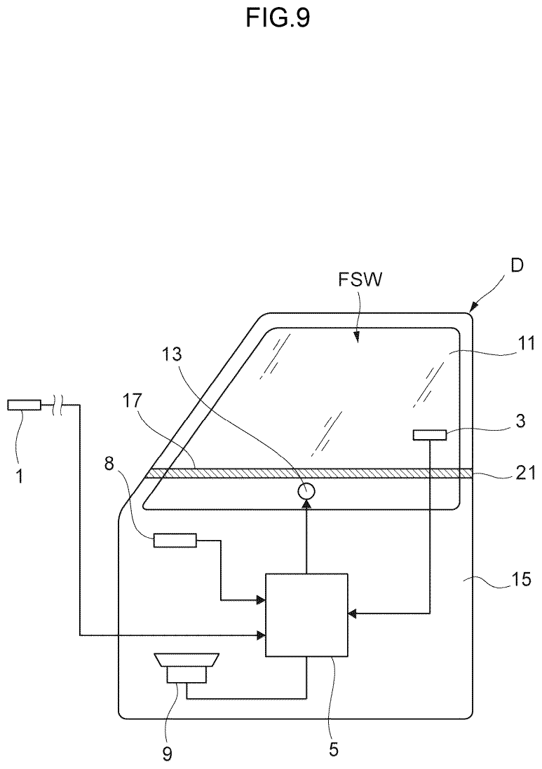

FIG. 9 is a schematic configuration diagram of a door D of the vehicle S installed with a vibration device of another configuration.

As illustrated in FIG. 9, this vibration device includes an interior space sound detection unit 8 configured from a microphone inside an interior space 19 of an enclosing member 15 that encloses an excitation region A1 of a glass sheet composite 11 to which a vibration output unit 13 has been attached. An auxiliary speaker 9 is also provided in the interior space 19. The interior space sound detection unit 8 and the auxiliary speaker 9 are each connected to a control unit 5.

The interior space sound detection unit 8 detects vibration sound from the excitation region A1 of the glass sheet composite 11 generated by vibration of the vibration output unit 13 and transmits this as an error signal to the control unit 5. According to the error signal from the interior space sound detection unit 8, the control unit 5 uses the adaptive algorithm 33 and the adaptive filter 35 to generate a cancellation signal to minimize the error signal from the interior space sound detection unit 8, and outputs cancellation sound to the auxiliary speaker 9. Vibration sound inside the interior space 19 from the excitation region A1 of the glass sheet composite 11 generated by vibration of the vibration output unit 13 is cancelled out by cancellation sound output from the auxiliary speaker 9.

This means that the vibration device according to this other exemplary embodiment, as well as vibrating the glass sheet composite 11 using the vibration output unit 13 so as to output sound faithful to the audio signal, is also able to cancel out secondary noise generated caused by vibration of the vibration output unit 13. This enables sound more faithful to the audio signal to be output in the interior of the vehicle S.

Moreover, in order to cancel out the sound caused by the vibration of the vibration output unit 13, the auxiliary speaker 9 that outputs the cancellation sound is provided in the interior space 19, however the output mode of the cancellation sound is not limited thereto. For example, a configuration may be adopted in which the auxiliary speaker 9 and the vibration output unit 13 have a common configuration, and may be configured such that cancellation sound to cancel out the sound generated caused by the vibration of the vibration output unit 13 is output from the vibration output unit 13.

A sound absorbing material such as felt, a sponge, or the like may be stuck to the inside and the outside of the enclosing member 15. A noise cancellation effect inside the interior space 19 is raised in such cases. Specifically, the sound absorbing material is preferably a resonance type sound absorbing material such as a multi-pore sound absorbing material, a perforated board, or the like, and is more preferably a multi-pore sound absorbing material from the perspective of the frequency bands where sound is absorbable. Moreover, a normal incidence sound absorption coefficient at 1 KHz of the sound absorbing material is preferably 0.25 or greater, is more preferably 0.5 or greater, and is even more preferably 0.75 or greater. A thickness of the sound absorbing material is preferably from 0.5 mm to 20 mm, and is more preferably a thickness from 1 mm to 10 mm. A face to which the sound absorbing material is stuck is preferably 25% or more of the surface area surrounding the interior space 19 of the enclosing member 15, and more preferably 50% or greater.

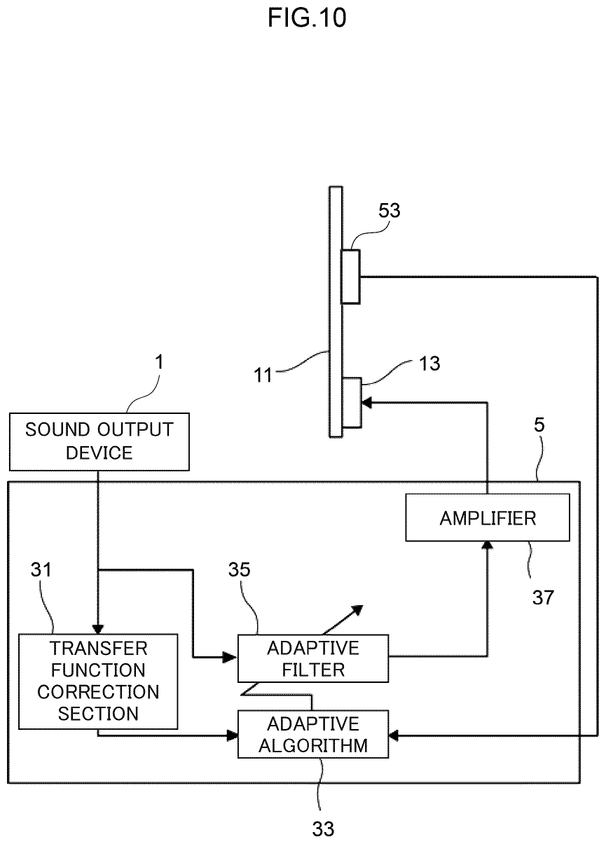

FIG. 10 is a functional block diagram of another configuration example of a vibration device.

Compared to the configuration example in FIG. 6 described above, an acceleration sensor 53 installed to a surface of a glass sheet composite 11 is employed instead of the interior sound detection unit 3. In this configuration example, similarly to the interior sound detection unit 3, output of the acceleration sensor 53 is transmitted to the control unit 5 as a detection signal.

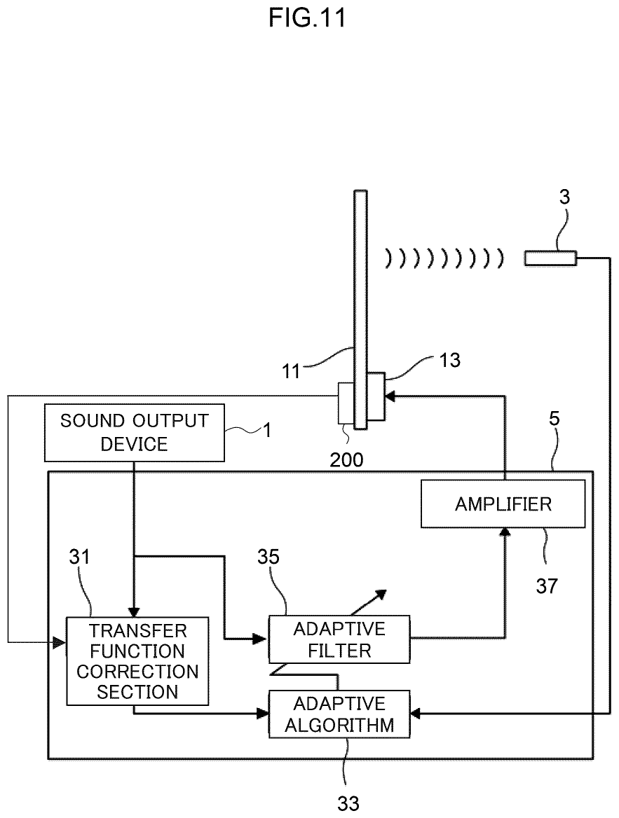

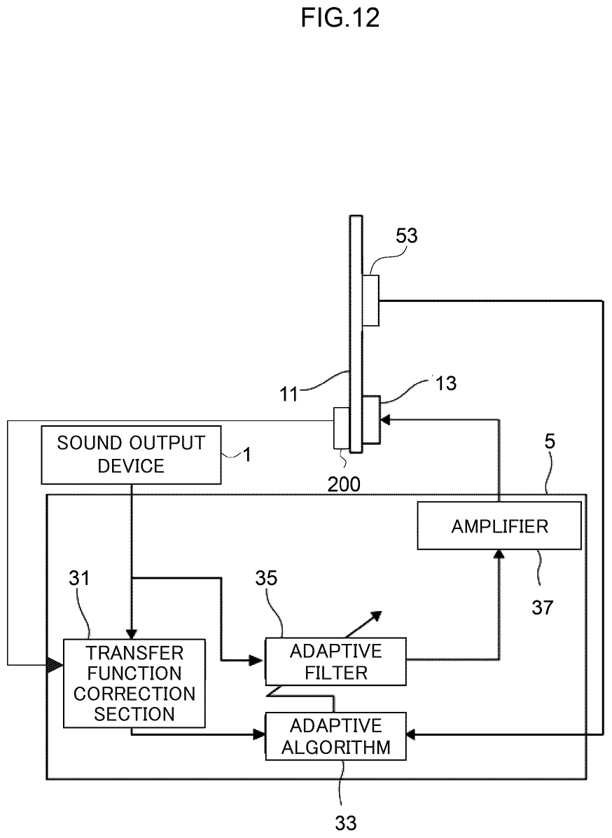

FIG. 11 and FIG. 12 are functional block diagrams of yet other configuration examples of a vibration device.

Response characteristics of a glass sheet composite 11 change depending on air temperature. This causes vibration attenuation characteristics (loss factor) of a glass plate of the glass sheet composite 11, or of an intermediate layer (adhesive layer or fluid layer, described later) thereof when laminated glass, to change according to changes in temperature. In order to correct performance differences arising from changes in temperature, in these configuration examples a parameter of the adaptive algorithm 33 is set according to the temperature of the glass sheet composite 11.

Specifically, as illustrated in FIG. 11 and FIG. 12, a temperature sensor 200 is employed installed to a surface of the glass sheet composite 11. The transfer function correction section 31 finds a transfer function at each temperature of the glass sheet composite 11, and sets the parameter of the adaptive algorithm 33 based on these transfer functions. The temperature sensor 200 can be employed as a temperature sensor installed other than on the surface of the glass sheet composite 11. For example, a temperature sensor may be installed so as to directly contact an intermediate layer. An external air thermometer installed at the inside of a periphery of a front grill, or a room thermometer installed to a vehicle interior, may also be employed. In such cases, a temperature of the intermediate layer of the glass sheet composite may be estimated with reference to data from plural temperature sensors.

The adaptive algorithm 33 and the adaptive filter 35 employ the parameter of the adaptive algorithm 33 that corresponds to the temperature detected by the temperature sensor 200 to generate the corrected signal obtained by correcting the audio signal transmitted from the sound output system 1.

### Second Exemplary Embodiment

Next, description follows regarding a vibration device according to a second exemplary embodiment. Note that the same reference numerals are appended to portions configured similarly to in the first exemplary embodiment, and explanation thereof will be omitted.

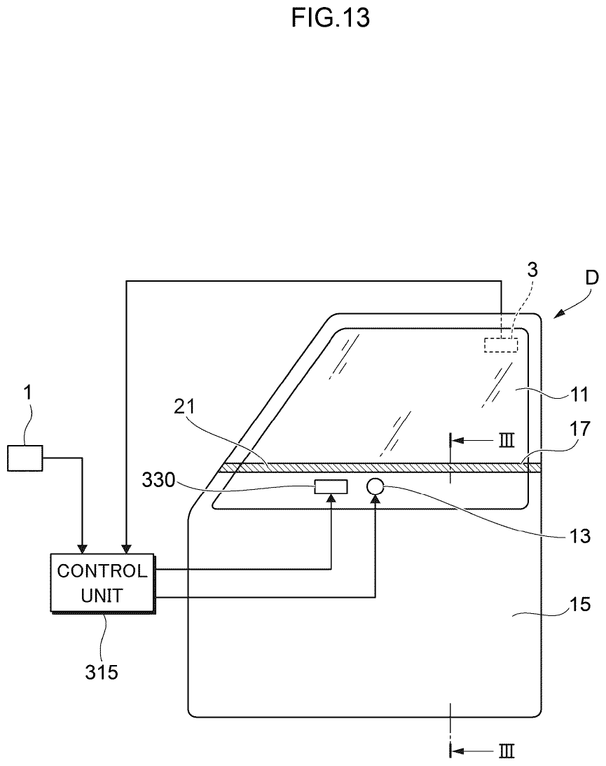

FIG. 13 is a schematic diagram of a vibration device provided to a door D of the vehicle S.

The vibration device includes a glass sheet composite 11, a vibration output unit 13 attached to the glass sheet composite 11, and a temperature regulation unit 330 to regulate the temperature of the glass sheet composite 11.

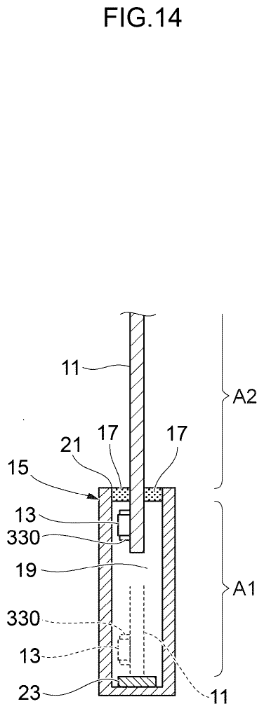

FIG. 14 is a schematic cross-section taken along line III-III in FIG. 13.

An enclosing member 15 includes an opening 21, with the glass sheet composite 11 protruded from the opening 21. At least one vibration output unit 13 is attached to the glass sheet composite 11.

The temperature regulation unit 330 is provided with a heating body to regulate the temperature of an intermediate layer of the glass sheet composite 11, or a structure including a heat retention function. The temperature regulation unit 330 may be provided to a face on one side of the glass sheet composite 11 as illustrated in FIG. 14, or may be provided to both faces thereof. Based on the temperature of the glass sheet composite 11, a peripheral member, or the ambient air as detected by a non-illustrated sensor section, the temperature regulation unit 330 may be configured so as to perform heating, cooling, heat retention, or the like of an intermediate layer according to a command signal from a control unit 315.

The enclosing member 15 is formed in a box shape enclosing portions of the glass sheet composite 11 where the vibration output unit 13 and the temperature regulation unit 330 are disposed. A shield member 17 is provided to the opening 21 of the enclosing member 15. The shield member 17 closes off the space at the interior space 19 of the enclosing member 15, and acoustically shields between the opening 21 and the glass sheet composite 11. Moreover, the glass sheet composite 11 is divided into an excitation region A1 where the vibration output unit 13 is provided inside the interior space 19, and a vibration region A2 at the outside of the interior space 19.

The excitation region A1 is, in other words, a region of the plate surface of the glass sheet composite 11 other than locations exposed to the outside from the interior space 19 of the enclosing member 15. Namely, the enclosing member 15 exposes one end of the glass sheet composite 11 to the outside of the interior space 19 through the opening 21 of the interior space 19. One end of the glass sheet composite 11 in this case means an end portion on a far side, from out of an end portion of the glass sheet composite 11 on the side near to positions where the vibration output unit 13 and the temperature regulation unit 330 are affixed and an end portion of the glass sheet composite 11 on the far side.

An audio signal output by a sound output system 1 is transmitted to the control unit 315.

### Vibration Control

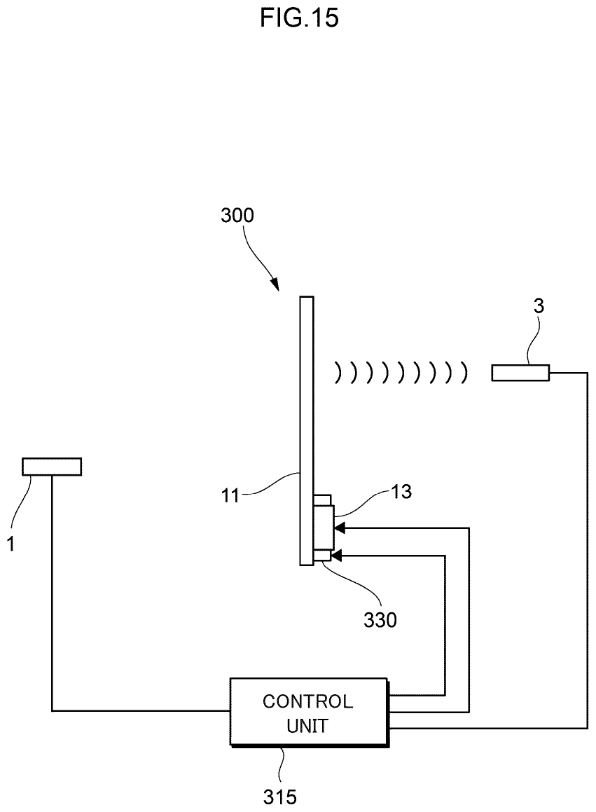

FIG. 15 is a functional block diagram of a vibration device applied to a vehicle S. Description follows regarding control of the vibration device, based on FIG. 15.

The control unit 315 is configured by a microcomputer including a processor such as a CPU or the like, memory such as ROM and RAM, storage, and the like. The sound output system 1 transmits an audio signal to the control unit 315. The interior sound detection unit 3 detects interior sound, and a detection result of the interior sound is transmitted as a detection signal to the control unit 315.

Similarly to the control unit 5 of the first exemplary embodiment, the control unit 315 includes a transfer function correction section 31, an adaptive algorithm 33, an adaptive filter 35, and an amplifier 37. The control unit 315 furthermore controls the temperature regulation unit 330.

### Glass Vibration Plate Configuration

Next, description follows regarding configurations of the glass sheet composite 11 employed in the vibration device described above.

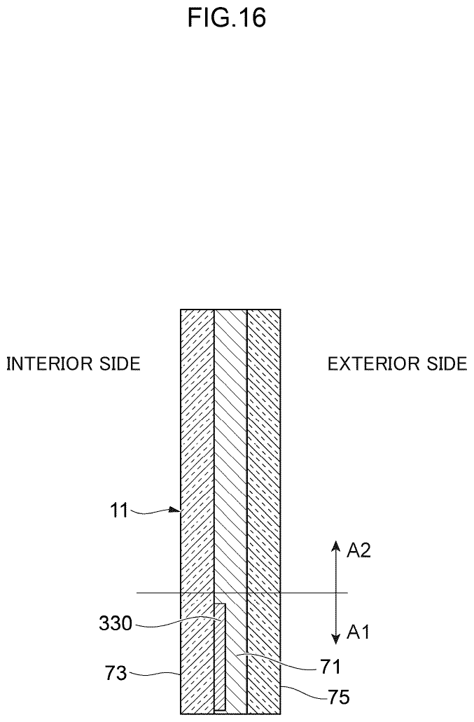

FIG. 16 is a schematic cross-section illustrating a configuration of the glass sheet composite 11.

In the glass sheet composite 11, a first glass plate 73 and a second glass plate 75 are disposed facing each other, with an intermediate layer 71 interposed between the first glass plate 73 and the second glass plate 75. Description follows regarding a case in which the first glass plate 73 is disposed on the interior side of a vehicle S, and the second glass plate 75 is disposed on the exterior side. In the following description, the first glass plate 73 and the second glass plate 75 will also sometimes be called sheet-pair glass plates 73, 75.

In cases in which the glass sheet composite 11 is resonated by driving of the vibration output unit 13, the intermediate layer 71 of the glass sheet composite 11 prevents resonance of the glass sheet composite 11, or attenuates fluctuations in resonation of the glass sheet composite 11. In the glass sheet composite 11, the loss factor is higher due to the presence of the intermediate layer 71 than cases in which configuration is with the glass sheet composite 11 alone.

The glass sheet composite 11 has a greater vibration attenuation and is more preferable as the loss factor increases, with the loss factor of the glass sheet composite 11 at 25° C. preferably 1×10⁻³ or greater, more preferably 2×10⁻³ or greater, and even more preferably 5×10⁻³ or greater. Regarding the speed of longitudinal wave sound in the thickness direction of the glass sheet composite 11, the reproducibility of high frequency sound is improved as the speed of sound in the vibration plate gets faster, and so the speed of longitudinal wave sound is preferably 4.0×10³ m/s or greater, is more preferably 4.5×10³ m/s or greater, and is still more preferably 5.0×10³ m/s or greater. There is no particularly limit to the upper value thereof, however 7.0×10³ m/s or less is preferable.

The glass sheet composite 11 includes the intermediate layer 71, and so the glass sheet composite 11 obtains a high loss factor and a high speed of longitudinal wave sound. Note that a large loss factor means that vibration attenuation capability is large.

The loss factor employed is one computed using a half-power beam width method. The loss factor is demarcated as a value expressed by {W/f}, wherein f is a resonance frequency of the material, and W is a frequency width of a point at −3 dB below a peak value of amplitude h, namely a point at max amplitude −3 (dB). The loss factor should be as large as possible to suppress resonance. Suppressing resonance means the frequency width W is larger relative to the amplitude h, and means the peak is broadened.

The loss factor is a characteristic value of a material or the like and, for example, differs according to composition, relative density, and the like when a single plate glass. Note that the loss factor can be measured using a dynamic modulus of elasticity test method such as a resonance method or the like. The speed of longitudinal wave sound is a speed with which longitudinal waves propagate in a vibration plate. The speed of longitudinal wave sound and Young's modulus can be measured by an ultrasound pulse method as described in Japanese Industrial Standard (JIS-R1602-1995).

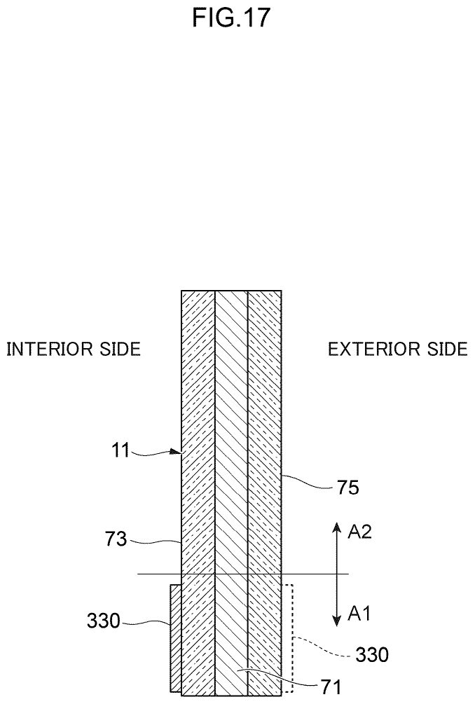

FIG. 17 is a schematic cross-section of a glass vibration plate illustrating another placement example of the temperature regulation unit illustrated in FIG. 16.

The temperature regulation unit 330 may be provided between the first glass plate 73 and the intermediate layer 71 as illustrated in FIG. 16, may be provided at the outside of the first glass plate 73 as illustrated in FIG. 17, and may be provided at the outside of both the first glass plate 73 and the second glass plate 75. The temperature regulation unit 330 may be provided in the excitation region A1, may be provided in both the excitation region A1 and the vibration region A2, or may be provided in only the vibration region A2.

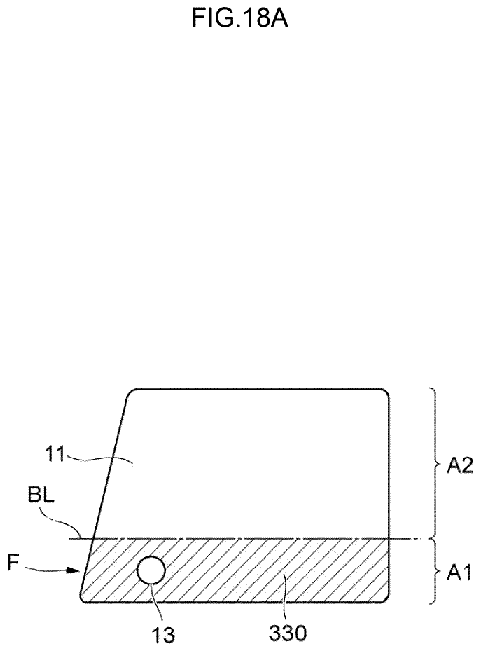

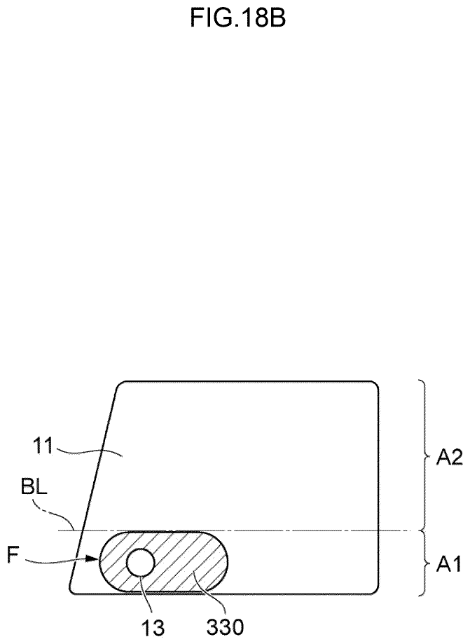

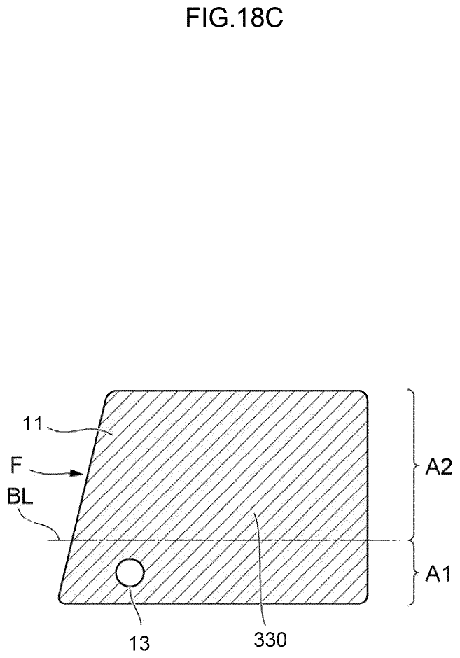

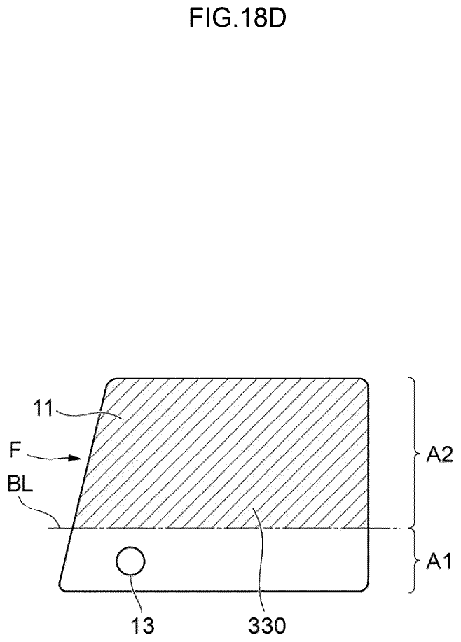

FIG. 18A to FIG. 18D are explanatory diagrams to illustrate placements on the glass sheet composite 11 of a temperature regulation region F from the temperature regulation unit 330. In FIG. 18A to FIG. 18D, regions (temperature regulation regions F) where the temperature regulation unit 330 is disposed are illustrated by shading, and positions where the shield member 17 is disposed at the opening 21 of the enclosing member 15 are illustrated as belt lines BL. In cases in which the glass sheet composite 11 is applied as a side window, the belt line BL corresponds to a lower edge of an open region (the vibration region A2) when the side window is attached to the door D of the vehicle S and is in a fully closed state.

In FIG. 18A, the temperature regulation region F is provided below the belt line BL, namely in the interior space 19 (see FIG. 14) of the enclosing member 15. Namely, the temperature regulation region F is provided only at a non-exposed portion of the glass sheet composite 11. In such cases, due to the temperature regulation unit 330 being disposed in the excitation region A1, an improvement can be secured in the vibration characteristics of the glass sheet composite 11. Moreover, due to the temperature regulation unit 330 being housed in a portion not exposed to the outside, the temperature regulation unit 330 is no longer able to be seen by a user and so good styling characteristics are achieved. Furthermore, the temperature regulation unit 330 is protected and not exposed to environmental conditions, such as ultraviolet radiation and thermal radiation from sunlight, wind, rain, and the like. This suppresses timewise deterioration of the temperature regulation unit 330.

In FIG. 18B, the temperature regulation region F is provided below the belt line BL and only at a periphery of the vibration output unit 13. In such cases, the temperature regulation region F can be suppressed to the minimum necessary, enabling a reduction in installation cost of the temperature regulation unit 330.

In FIG. 18C, the temperature regulation region F is provided in both the excitation region A1 and the vibration region A2 of the glass sheet composite 11. In such cases, an appropriate temperature is maintained over the entire glass sheet composite 11, enabling good vibration characteristics to be maintained.

In FIG. 18D, the temperature regulation region F is provided only to an exposed portion of the glass sheet composite 11 above the belt line BL. Such cases result in good vibration characteristics of the vibration region A2.

As described above, the temperature regulation region F can be appropriately selected according to usage objectives thereof, performance, sound blocking properties, and the like.

Examples of the temperature regulation unit 330 include a heating body, and materials or structures having a heat retention function, and the like. When heating, the intermediate layer 71 is heated using a heating body such as a hot wire, a conductor film, an electronic device, or the like, and for heat retention, the intermediate layer 71 is caused to track the vehicle interior temperature. Moreover, an electronic cooling device such as a Peltier device can be utilized when cooling. When a Peltier device is employed, heating and cooling are able to be selectively controlled, broadening a temperature regulation range.

Examples of the heating body include a conductor wire, a transparent conductor film (ITO), a film heater, and the like. A conductor wire is a hot wire heater, and can be installed over all the surface of the glass plate, or installed to each region alone, such as only the excitation region A1 below the belt line BL. A transparent conductor film and a film heater are both surface heaters including a heating face, and can be installed to each region similarly to a conductor wire, and can heat a wide surface area with good efficiency. Moreover, a Peltier device can be disposed in the excitation region A1 below the belt line BL alone. Furthermore, response characteristics of temperature regulation can be improved by providing a heating body to both faces of a glass vibration plate.

For heat retention, examples including a configuration in which an insulation layer is provided to a glass plate, and a configuration in which a plate thickness of a glass plate is thin and a heat transfer coefficient to an intermediate layer 71 has been raised.

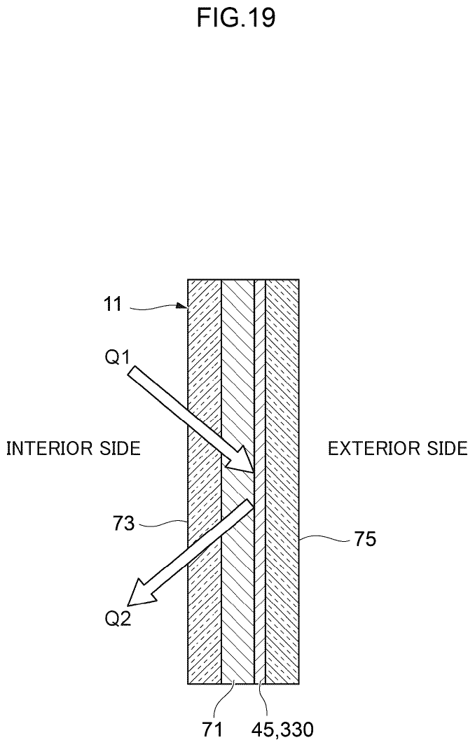

FIG. 19 is a partial cross-section illustrating a configuration in which a thermal radiation reflection layer has been provided to a glass vibration plate.

The glass sheet composite 11 illustrated in FIG. 19 includes a thermal radiation reflection layer 45 interposed between an intermediate layer 71 and a second glass plate 75. The thermal radiation reflection layer 45 serves a role of, when a heat input Q1 of heat from the interior side is introduced through the first glass plate 73 and the intermediate layer 71, suppressing this heat from escaping to the exterior side such that a reflection heat Q2 is returned back to the interior side. Efficient heat retention of the intermediate layer 71 can accordingly be achieved using heat at the interior side. The thermal radiation reflection layer 45 can, for example, be formed by forming a film of a material such as an ITO film, FTO film, or the like.

The thermal radiation reflection layer 45 functions as an insulation layer to suppress the heat input Q1 introduced to the intermediate layer 71 from escaping to the exterior side. An air layer is another example that can be given of such an insulation layer. An insulation layer such as the thermal radiation reflection layer 45 serves as the temperature regulation unit 330 by performing temperature regulation of the intermediate layer 71 utilizing the ambient air temperature at the interior side.

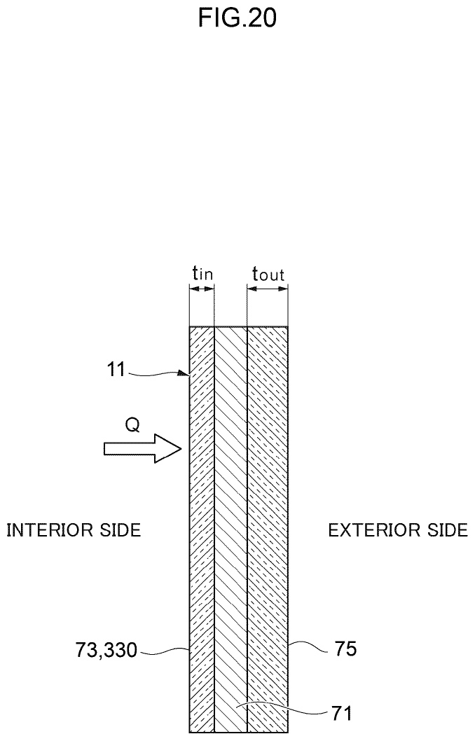

FIG. 20 is a partial cross-section illustrating a configuration of a glass vibration plate in which a plate thickness of one glass plate thereof is thinner than a plate thickness of another glass plate thereof.

In the glass sheet composite 11 illustrated in FIG. 20, a plate thickness tᵢₙ of a first glass plate 73 at the interior side is thinner than a plate thickness tₒᵤₜ of a second glass plate 75 at the exterior side (tᵢₙ<tₒᵤₜ).

Adopting such a configuration means that when a quantity of heat Q at the interior side is introduced to the intermediate layer 71 through the first glass plate 73, heat absorption by the first glass plate 73 is suppressed due to the first glass plate 73 being thin, thereby increasing the quantity of heat introduced to the intermediate layer 71. Given tᵢₙ=α tₒᵤₜ, the coefficient α can be set in a range of 0.0<α<1.0, is preferably 0.2≤α≤0.8, and is more preferably 0.5≤α≤0.7.

Namely, the temperature of the intermediate layer 71 is able to track the temperature at the interior side of the vehicle S in a short period of time. When the external air temperature is low, a heat quantity Q at the interior temperature higher than the external air temperature is utilized to heat the intermediate layer 71, and when the external air temperature is high, the intermediate layer 71 approaches the interior temperature lower than the external air temperature. Namely, the intermediate layer 71 is easily affected by the interior temperature. A combination of the first glass plate 73 and the second glass plate 75 configured with the most appropriate plate thicknesses accordingly functions as the temperature regulation unit 330.

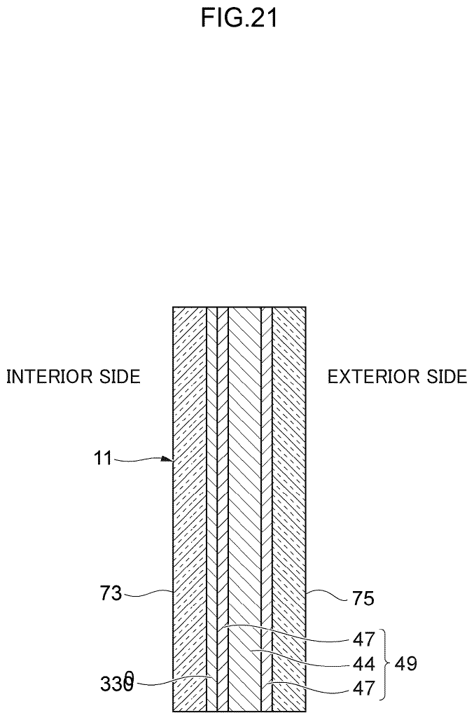

FIG. 21 is a cross-section illustrating another configuration example of a glass vibration plate.

The glass sheet composite 11 illustrated in FIG. 21 is provided with a layer of the temperature regulation unit 330 described above on a constituent-inside face of the first glass plate 73, resin layers 47 respectively provided between the layer of the temperature regulation unit 330 and the second glass plate 75, and furthermore a fluid layer 44 such as a gel form body, a liquid phase (for example a liquid crystal), or the like between the respective resin layers 47. The sheet-pair of resin layers 47 can be configured from resin films for sealing the fluid layer 44. An intermediate layer 49 is configured by the fluid layer 44 and the sheet-pair of resin layers 47.

However, a resin film, similarly to a solid phase intermediate layer 71 as described above, experiences a drop in ability to attenuate vibrations at low temperatures, and readily experiences resonance. Moreover, attenuation characteristics are improved when the temperature rises to room temperature or above (for example 40° C. or higher). This means that by providing the temperature regulation unit 330, such a glass sheet composite 11 is also able to raise attenuation properties with the resin layers 47, enabling efficient excitation of the glass sheet composite 11.

The glass sheet composite 11 described above is not limited to application to a side window of a vehicle S illustrated in FIG. 1.

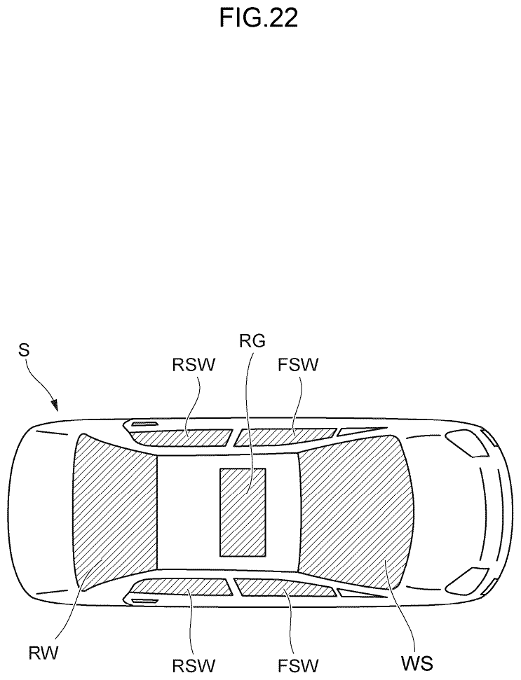

FIG. 22 is a plan view of a vehicle illustrating application locations of glass sheet composite 11 to a vehicle.

As illustrated in FIG. 22, other than to a front side window FSW, the glass sheet composite 11 may be provided to a rear side window RSW, a windshield WS, a rear window RW, a roof glazing RG, or the like. Moreover, although an example is illustrated above in which a portion of the front side window FSW is enclosed by the enclosing member 15, for a window glass other than the front side window FSW utilized as a glass vibration plate, an enclosing member 15 may or may not be included.

For example, in cases in which the glass sheet composite 11 configures a rear window RW, the visibility from the exterior can be improved by disposing a vibration output unit 13 such as an exciter or the like on a vehicle interior main face in the vicinity of the vehicle roof so as to be superimposed on a shielding layer that shields visible light such as a black ceramic or the like. For example, in cases in which the vibration output unit 13 is disposed on the rear window RW in the vicinity of the vehicle roof, one each (a total of two) vibration output units 13 may be provided at each vehicle width direction end along a boundary line between the rear window RW and the vehicle roof. In such cases, the vibration output units 13 are attached to the vehicle inside, and furthermore an enclosing member 15 may be provided so as to cover the vibration output units 13, enclosing so as to demarcate the interior space. Each of the exemplary embodiments as described above is of an example of a slidable glass sheet composite 11 of a vehicle, however there is no limitation to being a front side window FSW or a rear side window RSW, and application can be made to a fixed window such as a (so-called fixed) rear window RW fixed to the vehicle.

A vibration device is configured by these glass sheet composites 11, and the sound output system 1, the interior sound detection unit 3, and the control unit 315 illustrated in FIG. 1.

Moreover, application of the glass sheet composite 11 to the vehicle S is not limited to acoustic output, and may employed for the purpose of improving water repellency, water shedding properties, snow anti-stick properties, ice anti-stick properties, and anti-fouling properties by using sound wave vibration in a vehicle window, structural member, or decorative panel. Specifically, as well as application to an automobile window glass, mirror, a flat plate shape or curve plane shaped plate shaped member installed to the inside of a vehicle, application can also be made to a lens, sensor, or a cover glass therefor. Moreover, application can be made to a vehicle exterior speaker for the purpose of emitting sound to outside a vehicle.

Moreover, a vibration device can, other than to an automobile as described above, be applied to a railroad carriage, and other than to a vehicle S, application can be made, for example, to a window of an aircraft, a window of a ship or the like, a window of a building such as a home, or the like.

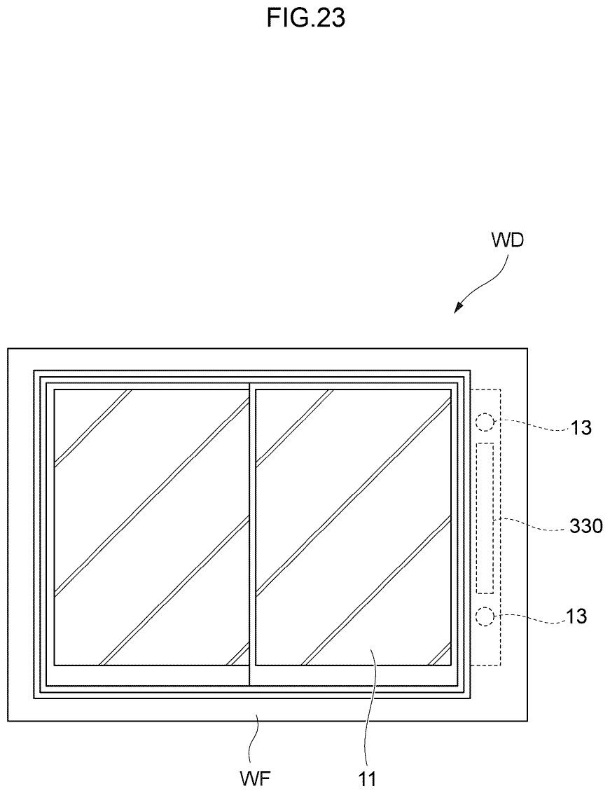

FIG. 23 is a schematic configuration diagram illustrating an example in which the glass sheet composite 11 has been applied to a window in a home.

As illustrated in FIG. 23, the glass sheet composite 11 is provided to a window WD of a home, and a window frame WF is provided to support the glass sheet composite 11. The vibration output unit 13 is attached to a portion of the surface of the glass sheet composite 11 disposed in an interior space of the window frame WF. One or plural vibration output units 13 may be provided. Moreover, a temperature regulation unit 330 is attached to at least a portion of the glass sheet composite 11. The temperature regulation unit 330 is preferably provided to an interior space of the window frame WF as illustrated in FIG. 18A, and a temperature regulation region F may be changed as appropriate as illustrated in FIG. 18B to FIG. 18D.

If a vibration device equipped with the glass sheet composite 11 is applied to a window WD of a home in this manner, the glass sheet composite 11 whose temperature is regulated by the temperature regulation unit 330 can be vibrated by the vibration output unit 13 to enable output of sound faithful to an audio signal.

Moreover, the glass sheet composite 11 may be imparted with a function such as cutting IR, cutting UV, a color tint, or the like. A configuration with raised functionality according to application can be achieved thereby.

As well as application of a vibration device to a window glass of a building as described above, examples also include application to a door glass, roof glass, interior finish material, exterior finish material, decorative material, structural material, external wall, solar cell cover glass, or the like. Furthermore, application can also be made to a partition and dresser or the like in a bank, hospital, hotel, restaurant, office, or the like. These may function as an acoustic reflection (reverberation) panel or a sound absorption panel. Moreover, the water repellency, snow anti-stick properties, and anti-fouling ability of the glass sheet composite 11 can be improved by sound wave vibration.

Moreover, the interior space 19 provided in the enclosing member 15 may, for example, be provided in another location other than a door panel of a vehicle, such as a body of a vehicle, and may be provided to a building member such as a window frame member, wall section, or the like.

Other than in a window of a mobile body such as a vehicle or the like, or a window of a building, the vibration device described above can also be utilized in an electronic device member. Examples of electronic device members utilized include, for example, a full-range speaker, a low frequency sound reproduction speaker for a 15 Hz to 200 Hz band, a high frequency sound reproduction speaker for a 10 kHz to 100 kHz band, a large speaker having a diaphragm surface area of 0.2 m² or above, a flat speaker, a cylindrical speaker, a transparent speaker, an electronic device cover glass functioning as a speaker, a TV display cover glass, a screen film, a display in which a picture signal and an audio signal are generated from the same screen, a lighting display, a light fitting, or the like. A speaker may be used for music, and may be used for warning sounds or the like. If a vibration detection element such as an acceleration sensor or the like is added, use may also be made as a diaphragm of a microphone, or a vibration sensor.

### Glass Plate

The glass sheet composite 11 employed in the glass sheet composite 11 means an inorganic glass or an organic glass. Examples of an organic glass include general well known transparent resins, such as a PMMA-based resin, a PC-based resin, a PS-based resin, a PET-based resin, a cellulose-based resin, or the like.

In addition to the sheet-pair glass sheet composite 11 sandwiching the intermediate layer 71, another glass plate may be further stacked thereon. Instead of a glass plate, the other glass plate may be an organic glass or inorganic glass as described above, may be a resin sheet made from a resin other than an organic glass, a metal plate such as aluminum, a ceramic plate made from a ceramic, or the like. Specifically, examples of a material of a metal plate employed instead of the other glass plate include aluminum, magnesium, copper, silver, gold, iron, titanium, SUS, or the like, and other alloy materials and the like thereof may be employed as necessary.

A physically toughened glass plate or a chemically toughened glass plate may be employed as at least one sheet of glass plates configuring the glass sheet composite 11. This is useful in preventing breakage of the glass plate. When there is a desire to raise the strength of a glass plate, a physically toughened glass plate or a chemically toughened glass plate may be employed as a glass plate positioned at the outermost surface from plural glass plates, and preferably a physically toughened glass plate or a chemically toughened glass plate is employed for all the glass plates configuring a vibration device.

Moreover, using a crystalized glass or a phase-separated glass as a glass plate is useful from the perspective of raising the speed of longitudinal wave sound therein and the strength thereof. In particular, when there is a desire to raise the strength of a glass plate, a crystalized glass or a phase-separated glass is preferably employed for the glass plate positioned at the outermost surface from out of plural glass plates.

A resin material configuring the glass plate is preferably a resin material capable of being molded into a flat plate shape or a curved plate shaped. Moreover, a resin material compounded with a high rigidity filler and carbon fibers, Kevlar fibers, or the like is preferable as a composite material and fiber material.

There are no particular limitations to the composition of a glass plate however, for example, within the following ranges are preferable. SiO₂: 40 to 80 mass %, Al₂O₃: 0 to 35 mass %, B₂O₃: 0 to 15 mass %, MgO: 0 to 20 mass %, CaO: 0 to 20 mass %, SrO: 0 to 20 mass %, BaO: 0 to 20 mass %, Li₂O: 0 to 20 mass %, Na₂O: 0 to 25 mass %, K₂O: 0 to 20 mass %, TiO₂: 0 to 10 mass %, and ZrO₂: 0 to 10 mass %. However, the above composition makes up 95 mass % or greater of the total glass.

A composition of a glass plate as expressed as an oxide-based mol % is more preferably in the following range.

SiO₂: 55 to 75 mass %, Al₂O₃: 0 to 25 mass %, B₂O₃: 0 to 12 mass %, MgO: 0 to 20 mass %, CaO: 0 to 20 mass %, SrO: 0 to 20 mass %, BaO: 0 to 20 mass %, Li₂O: 0 to 20 mass %, Na₂O: 0 to 25 mass %, K₂O: 0 to 15 mass %, TiO₂: 0 to 5 mass %, and ZrO₂: 0 to 5 mass %. However, the above composition makes up 95 mass % or greater of the total glass.

### Specific Configuration Examples of Intermediate Layer

Although a solid phase is preferable as an intermediate layer 71 interposed between plural sheets of the glass sheet composite 11 that have been stacked on each other, as described above, a fluid layer configured from a fluid such as gel-form body, a liquid such as a liquid crystal, or the like may be interposed between a sheet-pair of resin layers.

### Solid Phase Intermediate Layer

Preferably examples of an intermediate film of laminated glass employed as a solid phase intermediate layer 71 include polyvinyl butyral (PVB), ethylene vinyl acetate copolymer resins (EVA), polyurethane, polyethylene terephthalate, polycarbonate, and the like. When the intermediate layer 71 is configured by a resin layer, the thickness thereof may be in a range of from 0.3 mm to 3.0 mm for example, may be in a range of from 0.3 mm to 2.0 mm, and may be in a range of from 0.3 mm to 1.0 mm. Moreover, the thickness of the intermediate layer 71 does not necessarily need to be uniform, and a distribution of thicknesses may be set therefor so as to optimize the sound pressure frequency characteristics of the glass sheet composite 11. For example, the intermediate layer 71 may be wedge shaped with a thickness thereof having a distribution that gradually increases in a certain direction.

When the glass sheet composite 11 includes an intermediate layer 49 including a resin as described with reference to FIG. 21, if frequency characteristics differ depending on temperature, then this least to a distortion in sound pressure and phase, and there is a significant drop in active control performance. A resin has a glass transition temperature, and the glass transition temperature of the resin material employed is low in practice. Namely, good frequency characteristics are exhibited when at the glass transition temperature or above. However, if the temperature is raised too much then there is a drop in the rigidity of the plate, and excitation is no longer achieved efficiently.

This means that the temperature regulation unit 330 controls such that the intermediate layers 71, 49 are at a temperature that is the glass transition temperature of the resin material or above and that is 50° C. or lower, preferably 45° C. or lower, and more preferably 40° C. or lower, thereby enabling a glass sheet composite 11 with good frequency characteristics to be implemented.

### Fluid Layer

The glass sheet composite 11 may be provided with a fluid layer containing a liquid in an intermediate layer interposed between at least a sheet-pair of the glass sheet composite 11, and a high loss factor can be realized in such cases. From among such configurations, the loss factor is further raised by a viscosity and a surface tension of the fluid layer lying in preferable ranges. This differs from cases in which an adhesive layer is interposed in a sheet-pair of the glass sheet composite 11 in that the sheet-pair of the glass sheet composite 11 is not stuck together, and vibration characteristics can be thought of as continuing to be caused by each sheet of the sheet-pair glass sheet composite 11. Namely, “fluid” in the present specification has a meaning encompassing all substances having fluidity containing a liquid, such as a liquid, semi-solid, liquid crystal, mixture of solid powder and liquid, liquid-impregnated solid gel (jelly form substance), and the like.

A viscosity coefficient at 25° C. of the fluid layer is from 1×10⁻⁴ Pa·s to 1×10³ Pa·s, and the surface tension at 25° C. thereof is preferably from 15 mN/m to 80 mN/m. When viscosity is too low, vibration is not readily transferred, and when too high, the sheet-pair positioned at both sides of the fluid layer of the glass sheet composite 11 stick together, and vibration behavior exhibited is that of a single-sheet glass sheet composite 11, such that attenuation of resonant vibration is harder to achieve. Moreover, when surface tension is too low, an adhesion force within the glass sheet composite 11 falls, and vibration is not readily transferred. When the surface tension is too high, the sheet-pair positioned at both sides of the fluid layer of the glass sheet composite 11 readily stick together, and vibration behavior exhibited is that of a single-sheet glass sheet composite 11, such that attenuation of resonant vibration is harder to achieve.

Preferably the fluid layer is chemically stable, and the fluid layer and the sheet-pair positioned at both sides of the fluid layer of the glass sheet composite 11 do not react with each other. Chemical stability means, for example, something having little degeneration (deterioration) due to irradiation with light, moreover something for which solidification, vaporization, breaking down, discoloring, or a chemical reaction with glass, or the like does not occur at least in a temperature range of from −20° C. to 70° C.

Examples of constituents of the fluid layer include, specifically, water, an oil, an organic solvent, a liquid polymer, an ionic liquid, and mixtures and the like thereof. More specifically, examples include propylene glycol, di-propylene glycol, tri-propylene glycol, a straight silicone oil (di-methyl silicone oil, methyl phenyl silicone oil, methyl hydroxy silicone oil), denatured silicone oil, an acrylic-acid based polymer, a liquid polymer, a glycerin paste, a fluorine-based solvent, a fluorine-based resin, acetone, ethanol, xylene, toluene, water, a mineral oil, mixtures thereof, and the like. Preferable examples therefrom include at least one species selected from the group consisting of propylene glycol, a di-methyl silicone oil, a methyl phenyl silicone oil, a methyl hydroxy silicone oil, and a denatured silicone oil, and more preferable examples included propylene glycol or a silicone oil as a main component thereof.

The technology disclosed herein is not limited to the above exemplary embodiments, and the technology disclosed herein includes combinations of respective configurations of exemplary embodiments combined with each other, and modifications and applications anticipated by a person of ordinary skill in the art based on the present specification, and on known technology, also fall within the scope of protection claimed.

As described above, the present specification discloses the following matter.
(1) A vibration device including:
   a glass sheet composite equipped with at least one sheet of glass plate;
   a vibration output unit that is fixed to the glass sheet composite and that vibrates the glass sheet composite according to a signal that has been input;
   a detection unit that detects sound or vibration emitted by the glass sheet composite and outputs a detection signal according to a detection result;
   a signal output unit that outputs any selected audio signal; and
   a control unit that includes a controller that generates a corrected signal obtained by correcting the audio signal such that the detection signal and the audio signal correspond, and that inputs the corrected signal from the controller into the vibration output unit.

This vibration device enables sound faithful to the audio signal to be output by generating the corrected signal obtained by correcting the audio signal such that the detection signal according to the detection result from detecting sound or vibration emitted by the glass sheet composite corresponds to any selected audio signal, and by inputting this into the vibration output unit that vibrates the glass sheet composite.
(2) The vibration device of (1), further including a temperature detection unit that detects a temperature of the glass sheet composite, wherein:
the control unit
   includes a control parameter of the controller for each temperature of the glass sheet composite, and
   generates the corrected signal from the controller using a control parameter of the controller corresponding to a temperature of the glass sheet composite as detected by the temperature detection unit.

The vibration device is able to output sound faithful to the audio signal even if the temperature of the glass sheet composite changes.
(3) The vibration device of (1) or (2), wherein:
the control unit generates the corrected signal using an adaptive algorithm and an adaptive filter; and
the adaptive filter uses a target value of the audio signal as input of a feedforward controller, and uses a deviation between an output of the feedforward controller and the detection signal as input to a feedback controller.

This vibration device employs the feedforward controller and the feedback controller to enable sound faithful to the audio signal to be output.
(4) The vibration device of (1) or (2), wherein:
the control unit generates the corrected signal using an adaptive algorithm and an adaptive filter;
the adaptive filter uses a target value of the audio signal as input of a feedforward controller, and uses a deviation between the audio signal and the detection signal as input to a feedback controller; and
a sum of output of the feedback controller and output from the feedforward controller is output to the vibration output unit.

This vibration device employs the feedforward controller and the feedback controller to enable sound faithful to the audio signal to be output.
(5) The vibration device of any one of (1) to (4), further including an enclosing member that demarcates an interior space surrounding the vibration output unit fixed to the glass sheet composite, such that a portion of the glass sheet composite is exposed outside the interior space through an opening of the interior space.

This vibration device includes the vibration output unit fixed to the glass sheet composite, and disposed at the inside of the interior space demarcated by the enclosing member. This thereby enables leakage of noise from the interior space to be suppressed.
(6) The vibration device of (5), wherein the enclosing member is a window frame member that supports the glass sheet composite so as to be able to appear and disappear.

This vibration device enables noise transfer from outside to inside a window to be reliably suppressed irrespective of ambient temperature when a glass sheet composite configuring a window glass is closed.
(7) The vibration device of any one of (1) to (6), wherein the glass sheet composite includes a temperature regulation unit for regulating temperature.

This vibration device, by regulating the temperature of the glass sheet composite using the temperature regulation unit, enables a reduction in the effect of temperature on attenuation properties and frequency characteristics of the glass sheet composite, and enables the glass sheet composite to be reliably vibrated with the vibration characteristics required.
(8) The vibration device of (7), further including an enclosing member that demarcates an interior space surrounding the vibration output unit fixed to the glass sheet composite, such that a portion of the glass sheet composite is exposed outside the interior space through an opening of the interior space, wherein:
the temperature regulation unit is provided to a region of a plate surface of the glass sheet composite other than locations exposed to outside from the interior space of the enclosing member.

In this vibration device, the temperature regulation unit is no longer able to be seen by a user, resulting in good styling characteristics. Furthermore, the temperature regulation unit is suppressed from being exposed to environmental conditions.
(9) The vibration device of (7) or (8), wherein:
the glass sheet composite is a laminated glass including a first glass plate and a second glass plate, and an intermediate layer sandwiched between the first glass plate and the second glass plate; and
the temperature regulation unit includes a heating body that heats the intermediate layer.

This vibration device enables temperature regulation of the intermediate layer by heating using the temperature regulation unit.
(10) The vibration device of any one of (7) to (9), wherein the temperature regulation unit is disposed on both faces of the glass sheet composite.

This vibration device enables temperature regulation of the glass sheet composite from both faces thereof, improving the responsiveness of temperature regulation.
(11) The vibration device of any one of (7) to (10), wherein:
the glass sheet composite is a laminated glass including a first glass plate and a second glass plate, and an intermediate layer sandwiched between the first glass plate and the second glass plate; and
the temperature regulation unit includes a heat retention function of the intermediate layer.

This vibration device enables temperature regulation of the intermediate layer by heat retention using the temperature regulation unit. Moreover, the temperature regulation can be performed utilizing the temperature of the interior.
(12) The vibration device of (11), wherein the temperature regulation unit includes an insulation layer covering at least a portion of the intermediate layer.

This vibration device enables a drop in temperature to be suppressed by suppressing heat from escaping using the insulation layer.
(13) The vibration device of (12), wherein the insulation layer is a thermal radiation reflection layer.

This vibration device improves the efficiency of heat retention of the intermediate layer using the thermal radiation reflection layer.
(14) The vibration device of (11) or (12), wherein the temperature regulation unit increases input heat of the intermediate layer by making a thickness for one of the first glass plate or the second glass plate thinner than the other thereof.

In this vibration device, the heat absorption by the thin glass plate is suppressed, increasing input heat to the intermediate layer through the thin glass plate. This thereby enables heat to be incorporated into the intermediate layer without waste.
(15) The vibration device of any one of (11) to (14), wherein the intermediate layer is configured from a resin material including any from out of a polyvinyl butyral, an ethylene vinyl acetate copolymer resin, a polyurethane, a polyethylene terephthalate, or a polycarbonate.

In this vibration device, temperature regulation is accurately performed by the temperature regulation unit to the intermediate layer configured from a resin material with frequency characteristics that have a large temperature dependency.
(16) The vibration device of (15), wherein the temperature regulation unit makes the intermediate layer a temperature that is a glass transition temperature of the resin material or above and that is 50° C. or lower.

In this vibration device, resonance according to the temperature of the glass sheet composite is suppressed, enabling efficient excitation to be performed.
(17) The vibration device of any one of (1) to (16), wherein the glass sheet composite is at least one out of a side window, a rear window, a windshield, or a roof glazing of an automobile.

This vibration device enables sound true to an audio signal to be output from the glass sheet composite provided to a side window, a rear window, a windshield, a roof glazing, or the like of a vehicle.
(18) The vibration device of any one of (1) to (16), wherein the glass sheet composite is a window of any of a railroad carriage, an aircraft, a boat, or a building.

This vibration device enables sound true to an audio signal to be output from the glass sheet composite provided to a window of any of a railroad carriage, an aircraft, a boat, or a building.
(19) A vibration method that vibrates a glass sheet composite equipped with at least one sheet of glass plate according to a signal that has been input using a vibration output unit that is fixed to the glass sheet composite, the vibration method including:
detecting sound or vibration emitted by the glass sheet composite and outputting a detection signal according to a detection result;
outputting any selected audio signal;
using a controller to generate a corrected signal obtained by correcting the audio signal such that the detection signal and the audio signal correspond, and inputting the corrected signal from the controller into the vibration output unit; and
vibrating the glass sheet composite according to the corrected signal using the vibration output unit.

This vibration method enables sound true to an audio signal to be output by detecting the sound or vibration emitted by the glass sheet composite, generating the corrected signal obtained by correcting any selected audio signal such that the detection signal according to the detection result and the audio signal correspond, and inputting the corrected signal into the vibration output unit that vibrates the glass sheet composite.

The entire content of the disclosure of Japanese Patent Application No. 2022-083970 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. A vibration device comprising:
a glass sheet composite equipped with at least one sheet of glass plate;
a vibration output unit that is fixed to the glass sheet composite and that vibrates the glass sheet composite according to a signal that has been input;
a detection unit that detects sound or vibration emitted by the glass sheet composite and outputs a detection signal according to a detection result;
a signal output unit that outputs any selected audio signal; and
a control unit that includes a controller that generates a corrected signal obtained by correcting the audio signal such that the detection signal and the audio signal correspond, and that inputs the corrected signal from the controller into the vibration output unit.

2. The vibration device of claim 1, further comprising a temperature detection unit that detects a temperature of the glass sheet composite,
wherein the control unit:
includes a control parameter of the controller for each temperature of the glass sheet composite, and
generates the corrected signal from the controller using a control parameter of the controller corresponding to a temperature of the glass sheet composite as detected by the temperature detection unit.

3. The vibration device of claim 1, wherein:
the control unit generates the corrected signal using an adaptive algorithm and an adaptive filter; and
the adaptive filter uses a target value of the audio signal as input of a feedforward controller, and uses a deviation between an output of the feedforward controller and the detection signal as input to a feedback controller.

4. The vibration device of claim 1, wherein:
the control unit generates the corrected signal using an adaptive algorithm and an adaptive filter;
the adaptive filter uses a target value of the audio signal as input of a feedforward controller, and uses a deviation between the audio signal and the detection signal as input to a feedback controller; and
a sum of output of the feedback controller and output from the feedforward controller is output to the vibration output unit.

5. The vibration device of claim 1, further comprising an enclosing member that demarcates an interior space surrounding the vibration output unit fixed to the glass sheet composite, such that a portion of the glass sheet composite is exposed outside the interior space through an opening of the interior space.

6. The vibration device of claim 5, wherein the enclosing member is a window frame member that supports the glass sheet composite so as to be able to appear and disappear.

7. The vibration device of claim 1, wherein the glass sheet composite includes a temperature regulation unit for regulating temperature.

8. The vibration device of claim 7, further comprising an enclosing member that demarcates an interior space surrounding the vibration output unit fixed to the glass sheet composite, such that a portion of the glass sheet composite is exposed outside the interior space through an opening of the interior space,
wherein the temperature regulation unit is provided at a region of a plate surface of the glass sheet composite other than locations exposed outside the interior space of the enclosing member.

9. The vibration device of claim 7, wherein:
the glass sheet composite is a laminated glass including a first glass plate, a second glass plate, and an intermediate layer sandwiched between the first glass plate and the second glass plate; and
the temperature regulation unit includes a heating body that heats the intermediate layer.

10. The vibration device of claim 7, wherein the temperature regulation unit is disposed on both faces of the glass sheet composite.

11. The vibration device of claim 7, wherein:
the glass sheet composite is a laminated glass including a first glass plate, a second glass plate, and an intermediate layer sandwiched between the first glass plate and the second glass plate; and
the temperature regulation unit includes a heat retention function of the intermediate layer.

12. The vibration device of claim 11, wherein the temperature regulation unit includes an insulation layer covering at least a portion of the intermediate layer.

13. The vibration device of claim 12, wherein the insulation layer is a thermal radiation reflection layer.

14. The vibration device of claim 11, wherein the temperature regulation unit increases input heat of the intermediate layer by making a thickness for one of the first glass plate or the second glass plate thinner than the other thereof.

15. The vibration device of claim 11, wherein the intermediate layer is configured from a resin material including any of a polyvinyl butyral, an ethylene vinyl acetate copolymer resin, a polyurethane, a polyethylene terephthalate, or a polycarbonate.

16. The vibration device of claim 15, wherein the temperature regulation unit makes the intermediate layer a temperature that is equal to or greater than a glass transition temperature of the resin material and that is equal to or less than 50° C.

17. The vibration device of claim 1, wherein the glass sheet composite is at least one of a side window, a rear window, a windshield, or a roof glazing of an automobile.

18. The vibration device of claim 1, wherein the glass sheet composite is a window of any of a railroad carriage, an aircraft, a boat, or a building.

19. A vibration method that vibrates a glass sheet composite equipped with at least one sheet of glass plate according to a signal that has been input using a vibration output unit that is fixed to the glass sheet composite, the vibration method comprising:
detecting sound or vibration emitted by the glass sheet composite and outputting a detection signal according to a detection result;
outputting any selected audio signal;
using a controller to generate a corrected signal obtained by correcting the audio signal such that the detection signal and the audio signal correspond, and inputting the corrected signal from the controller into the vibration output unit; and
vibrating the glass sheet composite according to the corrected signal using the vibration output unit.
